(19) United States
(12) Patent Application Publication
(10) Pub. No.: US 2004/0253887 A1
(43) Pub. Date: Dec. 16, 2004

(54) Magnetic induction exothermic roller and method of producing the same, and heating device and image forming device

(76) Inventors: Noboru Katakabe, Uji-shi (JP); Masaru Imai, Hirakata-shi (JP); Keisuke Fujimoto, Hirakata-shi (JP)

Correspondence Address: MERCHANT & GOULD PC, P.O. BOX 2903, MINNEAPOLIS, MN, 55402-0903, US

(21) Appl. No.: 10/485,901

(22) PCT Filed: Oct. 31, 2002
(86) PCT No.: PCT/JP02/11327

(30) Foreign Application Priority Data
Nov. 1, 2001 (JP) 2001-336321

(51) Int. Cl. H05B 6/14; G03G 15/20; D03D 9/00; D03D 15/00

(52) U.S. Cl. 442/6; 165/177; 219/619; 219/665; 399/355; 428/692

(57) ABSTRACT

An electromagnetic induction exothermic roller (21) having, in the order from the surface, at least a release layer, induction exothermic layer (22), an elastic layer (23), and a core (24). Exothermic roller (21) is pressed by a press member (31) to form a nip portion (34) and heat up a heating subject material (11) passing through the nip portion (34). The induction exothermic layer (22) has a layer prepared by dispersing an electrically conductive filler in the base material consisting of a heat resistant resin or heat resistant rubber. For this reason, the induction exothermic layer (22) can easily deform, so that a nip portion (34) having a large width (W) can be formed. Further, the durability of the induction exothermic layer (22) against repeated bending is improved.

### TECHNICAL FIELD

The present invention relates to an electromagnetic induction heat generating roller that generates heat by electromagnetic induction heating for heating a sheet-like material to be heated by making continuous contact with the material to be heated. Specifically, this invention relates to an electromagnetic induction heat generating roller that is used in a heating device for fixing a toner image on a recording material by heating in an image forming apparatus that forms an image using toner by an electrophotographic method or another similar method that is used for copiers, printers and the like, and a method of manufacturing the induction heat generating roller. Moreover, this invention relates to a heating device and an image forming apparatus that use such an electromagnetic induction heat generating roller.

### BACKGROUND ART

Description will be made by using as an example a fixing device (heating device) in an image forming apparatus such as an electrophotographic copier, a printer or the like. A fixing device for use in image forming apparatuses is a device that permanently fixes an unfixed toner image on a surface of a recording material by heat. The unfixed toner image has been formed on the recording material using toner formed from a thermally meltable resin or the like. The fixing of the toner image is performed by an appropriate image formation processing method such as electrophotography, electrostatic recording or the like.

As a method used most commonly for such fixing devices, a roller fixing method has been known. In the roller fixing method, a recording material is introduced into a nip part formed by a heating roller that is heated and adjusted so that a predetermined fixing temperature is attained and a pressing roller that is opposed to and is in contact under pressure with the heating roller. At the nip part, the recording material is conveyed while being sandwiched between the rollers so that an unfixed toner image is fixed on a surface of the recording material by heating. As a heat source of a heating roller for use in the roller fixing method, a halogen lamp has been in frequent use.

Meanwhile, in recent years, in response to the demand for a reduction in power consumption and warm-up time, a belt fixing method that allows a reduction in the thermal capacity of a heating roller and an induction heating method in which as a heating source, a belt itself is caused to generate heat by electromagnetic induction, have been proposed. FIG. 7 shows an example of a conventional induction heating fixing device using an endless belt that is heated by electromagnetic induction (see, for example, JP10(1998)-74007 A).

In FIG. 7, reference numeral 160 denotes a coil assembly as an excitation unit that generates a high-frequency magnetic field. Reference numeral 110 denotes a metal sleeve (heat generating belt) that generates heat under a high-frequency magnetic field generated by the coil assembly 160. The metal sleeve 110 is formed by coating a surface of an endless tube made from a thin layer of nickel or stainless steel with a fluorocarbon resin. An inner pressing roller 120 is inserted in an inner portion of the metal sleeve 110, and an outer pressing roller 130 is placed outside the metal sleeve 110. The outer pressing roller 130 is pressed against the inner pressing roller 120 such that the metal sleeve 110 is interposed between them, and thus a nip part 250 is formed. While the metal sleeve 110, the inner pressing roller 120, and the outer pressing roller 130 rotate in the respective directions indicated by arrows, a high-frequency current is fed through the coil assembly 160. Thus, the metal sleeve 110 is heated rapidly by electromagnetic induction to a predetermined temperature. While predetermined heating is continued in this state, a recording material 140 is inserted into and passed through the nip part 230. Thus, a toner image formed on the recording material 140 is fixed on the recording material 140.

In the above-mentioned conventional induction heating fixing device, the metal sleeve 110 as the heat generating belt is formed of an endless belt made of a metal such as nickel or stainless steel, on a surface of which a mold releasing layer is formed. As in the above-mentioned case of forming a metallic endless belt by plating and plastic forming, productivity hardly is improved, resulting in a costly product. Further, in the case where the belt is formed from a metal, if the belt has a thickness of not more than 50 to 60 μm, it is difficult to achieve stable processing accuracy, and if the belt has a thickness equal to or larger than this, particularly, the belt is less resistant to repeated bending at the nip part and thus exhibits insufficient durability. Moreover, since the heat generating belt and the roller driving the heat generating belt are formed as separate members, the heat generating belt is driven to rotate unstably.

Furthermore, unlike the above-mentioned method using the heat generating belt, a roller heating method in which a metallic endless belt is fitted around an outer periphery of an elastic roller and is heated in the same manner by electromagnetic induction has been known. However, in a method of manufacturing a heat generating roller in which an endless belt is fitted around an elastic roller and bonded thereto, complex processing steps are required.

### DISCLOSURE OF THE INVENTION

It is an object of the present invention to solve the problems with the conventional technique and to provide a heat generating roller for use in the induction heating method that can be manufactured easily at lower cost and further achieves durability, and a method of manufacturing the heat generating roller. Further, it is another object of the present invention to provide a heating device that uses this heat generating roller for permanently fixing on a surface of a recording material an unfixed toner image that has been formed on the recording material, and an image forming apparatus including this heating device.

An electromagnetic induction heat generating roller according to the present invention includes at least a mold releasing layer, an induction heat generating layer, an elastic layer, and a core material, which are provided in this order from a surface. The electromagnetic induction heat generating roller is in contact under pressure with a pressing member so as to form a nip part and causes a temperature increase in a material to be heated being passed through the nip part. In the electromagnetic induction heat generating roller, the induction heat generating layer includes a layer formed of a base material of heat-resistant resin or heat-resistant rubber in which a conductive filler is dispersed.

Furthermore, a method of manufacturing the above-mentioned electromagnetic induction heat generating roller according to the present invention includes at least the steps of: forming the induction heat generating layer on the elastic layer by coating or spraying; and forming the mold releasing layer on the induction heat generating layer.

Furthermore, a heating device according to the present invention includes the above-mentioned electromagnetic induction heat generating roller according to the present invention, a pressing roller that is in contact under pressure with the electromagnetic induction heat generating roller so as to form the nip part, and a magnetic field generating unit that applies a magnetic field to the induction heat generating layer of the electromagnetic induction heat generating roller so that the induction heat generating layer generates heat by induction. In the heating device, a material to be heated that is introduced into the nip part is conveyed under pressure by the electromagnetic induction heat generating roller and the pressing roller so as to be heated continuously.

Moreover, an image forming apparatus according to the present invention includes an image forming unit that forms a toner image on a recording material and the above-mentioned heating device according to the present invention. In the image forming apparatus, the toner image to be fixed formed on the recording material by the image forming unit is fixed on the recording material by the heating device.

### BRIEF DESCRIPTION OF THE DRAWINGS

FIG. 1 is a cross sectional view of a heating device according to Embodiment 1 of the present invention.

FIG. 2 is a structural view of a magnetic field generating unit as seen from a direction indicated by an arrow II of FIG. 1.

FIG. 3 is a cross sectional view taken on line III-III of FIG. 2 for showing the heating device according to Embodiment 1 of the present invention.

FIG. 4A is a cross sectional view of a heat generating roller according to Embodiment 1 of the present invention that is used in a fixing device shown in FIG. 1. FIG. 4B is an expanded sectional view of a portion 4B shown in FIG. 4A.

FIG. 5 is a cross sectional view schematically showing a configuration of an image forming apparatus according to an embodiment of the present invention.

FIG. 6 is an expanded sectional view of a portion in the vicinity of a surface of a heat generating roller according to Embodiment 2 of the present invention.

FIG. 7 is a cross sectional view of a conventional induction heating fixing device.

### BEST MODE FOR CARRYING OUT THE INVENTION

An induction heat generating roller according to the present invention includes at least a mold releasing layer, an induction heat generating layer, an elastic layer, and a core material, which are provided in this order from a surface. In the induction heat generating roller, the induction heat generating layer includes a layer formed of a base material of heat-resistant resin or heat-resistant rubber in which a conductive filler is dispersed.

Accordingly, the base material of the induction heat generating layer is formed of a flexible material of resin or rubber and not of a thin metal layer. Thus, the induction heat generating layer is deformed easily, thereby allowing a nip part having a large width to be formed. Further, the induction heat generating layer is increased in durability with respect to repeated bending.

Preferably, the induction heat generating layer is formed of a laminate of a layer formed of a base material in which a conductive filler is dispersed and a layer formed of a base material in which a magnetic filler having a resistance higher than that of the conductive filler is dispersed.

According to this preferred embodiment, compared with the case where the induction heat generating layer is formed only of a single layer in which a conductive filler is dispersed, the efficiency of heat generation due to an alternating magnetic field further can be increased. Further, leakage magnetic flux, which is magnetic flux penetrating the induction heat generating layer and then reaching the core material, can be decreased. This eliminates the need for taking the heat generation of the core material into consideration, and thus a less costly material having sufficient mechanical strength can be used for the core material. Further, the heat generation of the core material can be suppressed, and thus heat damage to the bearings for the core material can be prevented.

Preferably, the base material of the induction heat generating layer is formed from a silicone rubber.

According to this preferred embodiment, the induction heat generating layer is formed of the base material of a silicone rubber in which the conductive filler is dispersed. Thus, the induction heat generating layer can be formed easily on the elastic layer by coating or the like. Further, the induction heat generating layer also is increased in flexibility.

Preferably, the elastic layer is formed from a foamed silicone rubber.

According to this preferred embodiment, the elastic layer has a high heat insulating property as well as flexibility and heat resistance, and thus the surface temperature of the electromagnetic induction heat generating roller can be increased rapidly.

Preferably, the induction heat generating layer is formed directly on a surface of the elastic layer by coating or spraying.

According to this preferred embodiment, compared with the case of a heat generating roller formed in the conventional manner in which as an induction heat generating layer, a tube formed of a thin metal layer is formed separately from an elastic layer and then is fitted around the elastic layer, manufacturing of a heat generating roller is made easier. Further, in the case where a tube is bonded, if unevenness results from bonding, such unevenness is likely to cause variations in the surface temperature of a roller. On the contrary, in the case where the induction heat generating layer is formed directly on the elastic layer, joining of the layers is achieved without causing unevenness, and thus variations in the surface temperature of the roller hardly occur.

Preferably, a second elastic layer is provided between the mold releasing layer and the induction heat generating layer.

According to this preferred embodiment, variations in surface temperature can be reduced, and a uniform contact with a surface of a recording material can be secured.

Next, a method of manufacturing the above-mentioned electromagnetic induction heat generating roller according to the present invention includes at least the steps of: forming the induction heat generating layer on the elastic layer by coating or spraying; and forming the mold releasing layer on the induction heat generating layer.

Accordingly, an electromagnetic induction heat generating roller that allows manufacturing process steps to be simplified and achieves excellent properties in terms of durability, prevention of temperature variations and the like can be formed.

Furthermore, a method of manufacturing the electromagnetic induction heat generating roller according to the present invention with the second elastic layer includes at least the steps of: forming the induction heat generating layer on the elastic layer by coating or spraying; forming the second elastic layer on the induction heat generating layer; and forming the mold releasing layer on the second elastic layer.

Accordingly, the induction heat generating layer, the second elastic layer, and the mold releasing layer are formed in sequence, and thus manufacturing is made easier.

Next, a heating device according to the present invention includes the above-mentioned electromagnetic induction heat generating roller according to the present invention, a pressing roller that is in contact under pressure with the electromagnetic induction heat generating roller so as to form the nip part, and a magnetic field generating unit that applies a magnetic field to the induction heat generating layer of the electromagnetic induction heat generating roller so that the induction heat generating layer generates heat by induction. In the heating device, a material to be heated that is introduced into the nip part is conveyed under pressure by the electromagnetic induction heat generating roller and the pressing roller so as to be heated continuously.

Accordingly, a heating device that achieves an extremely short warm-up time, high durability, and uniform heating with high stability can be realized.

Furthermore, an image forming apparatus according to the present invention includes an image forming unit that forms a toner image on a recording material and the above-mentioned heating device according to the present invention. In the image forming apparatus, the toner image to be fixed formed on the recording material by the image forming unit is fixed on the recording material by the heating device.

Accordingly, an image forming apparatus that achieves a shorter warm-up time, has durability, and enables uniform fixing of a toner image can be realized.

Hereinafter, the present invention will be described in further detail with reference to the appended drawings.

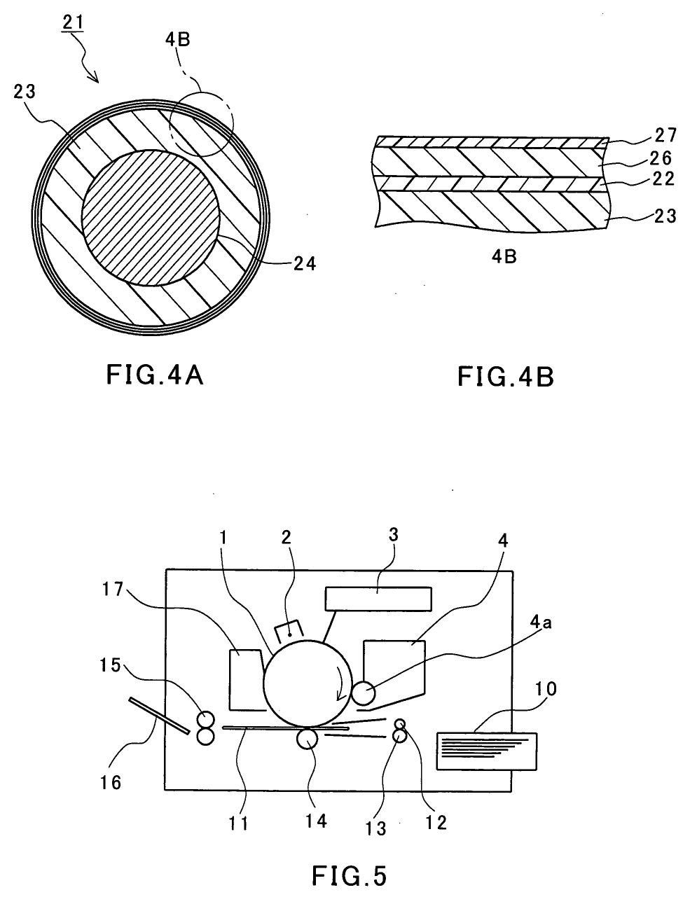

FIG. 5 is a cross sectional view of an image forming apparatus using a heating device according to an embodiment of the present invention as a fixing device. The following description is directed to the configuration and operation of this apparatus.

Reference numeral 1 denotes an electrophotographic photoreceptor (hereinafter, referred to as a “photosensitive drum”). The photosensitive drum 1, while being driven to rotate at a predetermined peripheral velocity in a direction indicated by an arrow, has its surface charged uniformly to a predetermined potential by a charger 2. Reference numeral 3 denotes a laser beam scanner that outputs a laser beam modulated in accordance with a time-series electric digital pixel signal of image information input from a host device such as an image reading apparatus, a computer or the like, which is not shown in the figure. The surface of the photosensitive drum 1 charged uniformly as described above is scanned by and exposed to this laser beam selectively. This allows a static latent image corresponding to the image information to be formed on the surface of the photosensitive drum 1. Next, the static latent image is supplied with powdered toner charged by a developer 4 having a developing roller 4a that is driven to rotate, and made manifest as a toner image.

Meanwhile, a recording material 11 is fed one at a time from a paper feeding part 10 and passed between a pair of resist rollers 12 and 13. Then, the recording material 11 is conveyed to a nip part composed of the photosensitive drum 1 and a transferring roller 14 that is in contact with the photosensitive drum 1, and the timing thereof is appropriate and synchronized with the rotation of the photosensitive drum 1. By the action of the transferring roller 14 to which a transfer bias is applied, toner images on the photosensitive drum 1 are transferred one after another to the recording material 11. The recording material 11 that has been passed through the nip part (transferring part) is released from the photosensitive drum 1 and introduced to a fixing device 15 where fixing of the transferred toner image is performed. The recording material 11 on which the image is fixed by the fixing process is output to a paper ejecting tray 16. The surface of the photosensitive drum 1 from which the recording material has been released is cleaned by removing residual materials such as toner remaining after the transferring process by a cleaning device 17 and used repeatedly for successive image formation.

Next, an embodiment of the heating device according to the present invention that can be used as the above-mentioned fixing device 15 will be described in detail by way of an example.

### EMBODIMENT 1

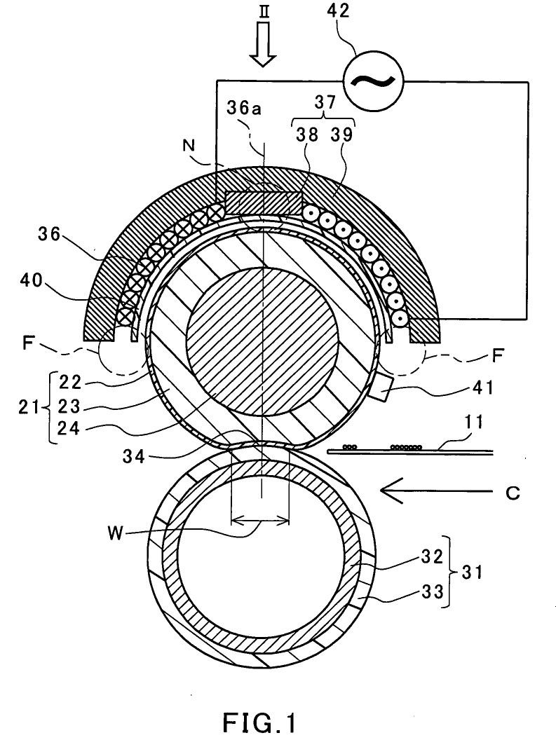

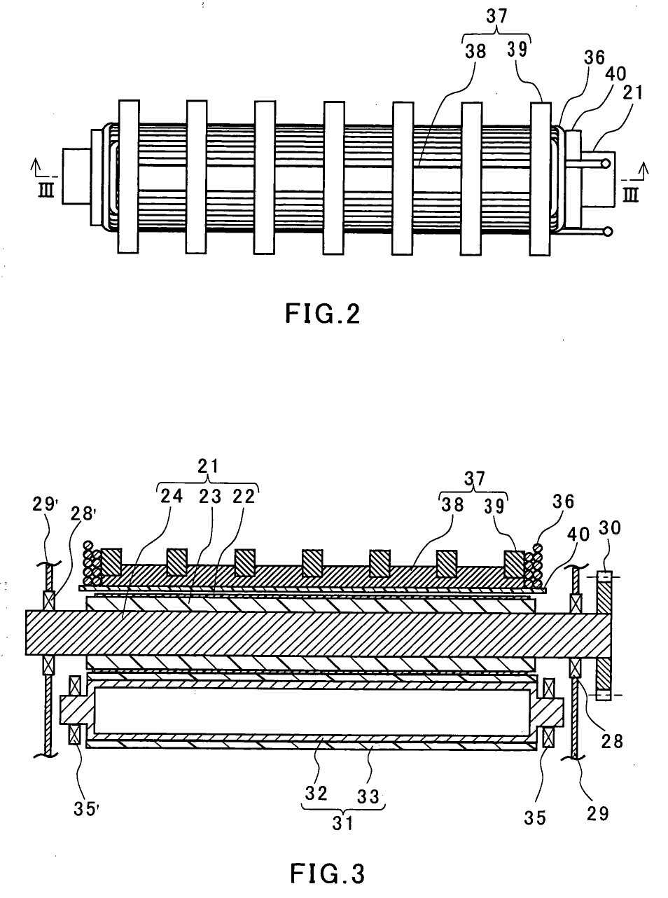

FIG. 1 is a cross sectional view of a fixing device as a heating device according to Embodiment 1 of the present invention that is used in the above-mentioned image forming apparatus. FIG. 2 is a structural view of a magnetic field generating unit as seen from a direction indicated by an arrow II of FIG. 1. FIG. 3 is a perspective sectional view taken on line III-III (a plane including a rotation center axis of a heat generating roller 21 and a winding center axis 36a of an excitation coil 36) of FIG. 2. FIG. 4A is a sectional structural view of the heat generating roller 21 according to the present invention that is used in the fixing device shown in FIG. 1. FIG. 4B is an expanded sectional view of a portion 4B shown in FIG. 4A. The following description is directed to the fixing device and the heat generating roller according to this embodiment with reference to FIGS. 1 to 4B.

In FIGS. 4A and 4B, the heat generating roller 21 is composed of a mold releasing layer 27, a thin elastic layer (second elastic layer) 26, an induction heat generating layer (hereinafter, referred to simply as “heat generating layer”) 22 that is formed of a thin conductive material, an elastic layer 23 that has an excellent heat insulating property, and a core material 24 that is to function as a rotary shaft, which are provided in this order from a surface side.

FIG. 3 is a perspective sectional view taken on line III-III of FIG. 2 and shows a configuration of the whole fixing device as seen in cross section from a lateral direction. The heat generating roller 21 has an outer diameter of 30 mm and is supported rotatably by side plates 29, 29′ via bearings 28, 28′ at both ends of the core material 24 that is the lowest layer thereof. The heat generating roller 21 is driven to rotate by a driving unit of a main body of the apparatus, which is not shown in the figure, through a gear 30 fixed integrally to the core material 24.

Reference numeral 36 denotes the excitation coil as the magnetic field generating unit. The excitation coil 36 is disposed so as to be opposed to a cylindrical face on an outer periphery of the heat generating roller 21. Further, the excitation coil 36 includes nine turns of a wire bundle composed of 60 wires of a copper wire with its surface insulated, which has an outer diameter of 0.15 mm.

The wire bundle of the excitation coil 36 is arranged, at end portions of the cylindrical face of the heat generating roller 21 in a direction of the rotation center axis (not shown in the figure), in the form of an arc along outer peripheral faces of the end portions. The wire bundle is arranged, in a portion other than the end portions, along a direction of a generatrix of the cylindrical face. Further, as shown in FIG. 1, which is a cross section orthogonal to the rotation center axis of the heat generating roller 21, the wire bundle of the excitation coil 36 is arranged tightly without being overlapped (except at the end portions of the heat generating roller) on an assumed cylindrical face formed around the rotation center axis of the heat generating roller 21 so as to cover the cylindrical face of the heat generating roller 21. Further, as shown in FIG. 3, which is a cross section including the rotation center axis of the heat generating roller 21, in portions opposed to the end portions of the heat generating roller 21, the wire bundle of the excitation coil 36 is overlapped in two rows and thus forced into bulges. Thus, the whole excitation coil 36 is formed into a saddle-like shape. The winding center axis 36a of the excitation coil 36 is a straight line substantially orthogonal to the rotation center axis of the heat generating roller 21, which passes through substantially a center point of the heat generating roller 21 in the direction of the rotation center axis. The excitation coil 36 is formed so as to be substantially symmetrical with respect to the winding center axis 36a. The wire bundle is wound so that adjacent turns of the wire bundle are bonded to each other with an adhesive applied to their surface, thereby maintaining a shape shown in the figure. The excitation coil 36 is opposed to the heat generating roller 21 at a distance of about 2 mm from an outer peripheral face of the heat generating roller 21. In the cross section shown in FIG. 1, the excitation coil 36 is opposed to the outer peripheral face of the heat generating roller 21 in a large area defined by an angle of about 180 degrees with respect to the rotation center axis of the heat generating roller 21.

Reference numeral 37 denotes a rear core, which together with the excitation coil 36, constitutes the magnetic field generating unit. The rear core 37 is composed of a bar-like central core 38 and a substantially U-shaped core 39. The central core 38 passes through the winding center axis 36a of the excitation coil 36 and is arranged parallel to the rotation center axis of the heat generating roller 21. The U-shaped core 39 is arranged at a distance from the excitation coil 36 on a side opposite to that of the heat generating roller 21 with respect to the excitation coil 36. The central core 38 and the U-shaped core 39 are connected magnetically. As shown in FIG. 1, the U-shaped core 39 is of a U shape substantially symmetrical with respect to a plane including the rotation center axis of the heat generating roller 21 and the winding center axis 36a of the excitation coil 36. As shown in FIGS. 2 and 3, a plurality of the U-shaped cores 39 described above are arranged at a distance from each other in the direction of the rotation center axis of the heat generating roller 21. In this example, the width of the U-shaped core 39 in the direction of the rotation center axis of the heat generating roller 21 is 10 mm, and seven such U-shaped cores 39 in total are spaced at a distance of 26 mm from each other. The U-shaped cores 39 capture magnetic flux from the excitation coil 3, which leaks to the exterior.

As shown in FIG. 1, both ends of each of the U-shaped cores 39 are extended to areas that are not opposed to the excitation coil 36, so that opposing portions F are formed, which are opposed to the heat generating roller 21 without the excitation coil 36 interposed between them. Further, the central core 38 is opposed to the heat generating roller 21 without the excitation coil 36 interposed between them and protrudes further than the U-shaped core 39 to a side of the heat generating roller 21 to form an opposing portion N. The opposing portion N of the protruding central core 38 is inserted into a hollow portion of a winding center of the excitation coil 36. The central core 38 has a cross-sectional area of 4 mm by 10 mm.

In this example, the rear core 37 was formed from ferrite. As a material of the rear core 37, it is desirable to use a material having high magnetic permeability and a high specific resistance such as ferrite, Permalloy or the like. However, a material having somewhat low magnetic permeability also can be used as long as the material is a magnetic material.

Reference numeral 40 denotes a heat insulating member that has a thickness of 1 mm and is formed from a resin having high heat resistance such as PEEK (polyether ether ketones), PPS (polyphenylene sulfide) or the like.

In FIG. 1, a pressing roller 31 as a pressing member is formed of a metal shaft 32 whose surface is coated with an elastic layer 33 of a silicone rubber. The elastic layer has a hardness of 50 degrees (JIS-A). The pressing roller 31 is in contact under pressure with the heat generating roller 21 with a force of about 200 N in total, and thus a nip part 34 is formed. The pressing roller 31 has an outer diameter of 30 mm and a length that is substantially the same as that of the heat generating roller 21, while having an effective length slightly larger than the length of the heat generating layer 22.

At the nip part 34, the elastic layer 23 of the heat generating roller 21 is deformed by compression, and the heat generating layer 22 is pressed with substantially a uniform pressure in a width direction (the direction of the rotation center axis of the heat generating roller 21). The nip part 34 has a width W along a moving direction C of a recording material 11 of about 5.5 mm. Although an extremely large force is applied to the heat generating roller 21 and the heat generating layer 22 on a surface of the heat generating roller 21 is thin, the nip part 34 is formed such that the width W is substantially uniform in the direction of the rotation center axis. This can be achieved because the solid core material 24 bears the pressure through the elastic layer 23, and thus distortion with respect to the rotation center axis is suppressed to a minimal amount. Moreover, at the nip part 34, the heat generating layer 22 and the elastic layer 23 are deformed into the shape of a concave along an outer peripheral face of the pressing roller 31. Therefore, when the recording material 11 comes out of the nip part 34 after passing therethrough, a traveling direction of the recording material 11 is on an increased angle with respect to an outer surface of the heat generating roller 21, thereby achieving an excellent peeling property for the recording material 11.

The pressing roller 31 in this state is supported rotatably by follower bearings 35, 35′ at both ends of the metal shaft 32. As a material of the elastic layer 33 of the pressing roller 31, as well as the above-mentioned silicone rubber, heat-resistant resin and heat-resistant rubber such as fluorocarbon rubber, fluorocarbon resin and the like may be used. Further, in order to obtain improved abrasion resistance and mold releasability, a surface of the pressing roller 31 may be coated with a single material or a combination of materials selected from resin and rubber such as PFA (tetrafluoroethylene-perfluoroalkylvinyl ether copolymer), PTFE (polytetrafluoroethylene), FEP (tetrafluoroethylene hexafluoropropylene copolymer) and the like. In order to prevent heat dissipation, it is desirable that the pressing roller 31 be formed of a material having low thermal conductivity.

In FIG. 1, reference numeral 41 denotes a temperature detecting sensor that is in contact with the surface of the heat generating roller 21 so as to detect the temperature of the surface of the heat generating roller 21 at a portion right before entering the nip part 34, and feeds back a result of the detection to a controlling circuit that is not shown in the figure. During operation, this function is used to regulate an excitation power of an excitation circuit 42, and thus a temperature of the surface of the heat generating roller 21 at a portion right before entering the nip part 34 is controlled so as to be 170 degrees centigrade. In this example, in order to achieve the object of reducing a warm-up time, the elastic layer 26 and the mold releasing layer 27 that are provided on an outer side of the heat generating layer 22, like the heat generating layer 22, are set so as to have an extremely small thermal capacity.

Using the above-mentioned configuration, while the heat generating roller 21 and the pressing roller 31 are rotated, a high-frequency current at 20 to 50 kHz is fed to the excitation coil 36 by the excitation circuit 42. This causes alternating magnetic flux to flow via the central core 38 and the U-shaped cores 39 that surround the excitation coil 36 and the heat generating layer 22 of the heat generating roller 21 that is opposed to the excitation coil 36. Due to this alternating magnetic flux, an eddy current is generated in the heat generating layer 22, so that the surface temperature of the heat generating roller 21 begins to increase rapidly. The surface temperature of the heat generating roller 21 is detected by the temperature detecting sensor 41 and adjusted to a predetermined temperature of 170° C. Then, the recording material 11 carrying unfixed toner images is inserted into the nip part 34 where the toner images and the recording material 11 are heated successively, so that the toner images are fixed on the recording material 11.

Next, the configuration of the heat generating roller 21 will be described in detail.

In this example, the core material 24 was formed of a PPS (polyphenylene sulfide) material having a diameter of 20 mm. As a material of the core material 24, preferably, a heat-resistant material having high mechanical strength (bending rigidity in the direction of the rotation center axis) is used. Moreover, in order to allow passing of magnetic flux through the core material 24 to be hindered as much as possible, preferably, a material having a high magnetic resistance is used. Further, in order to allow the generation of an eddy current to be prevented even when leakage magnetic flux passes through the core material 24, preferably, a material having an insulating property is used. As a heat-resistant insulating material, a ceramic material such as alumina also can be used.

The elastic layer 23 is formed of a foam body of a silicone rubber having low thermal conductivity. In the example, the elastic layer 23 is set to have a thickness of 5 mm and a hardness of 45 degrees (ASKER-C). Although the material of the elastic layer 23 is not limited to a foamed silicone rubber, it is desirable to use a material having a hardness of 20 to 55 degrees (ASKER-C) so that the width W of the nip part 34 is secured with moderate elasticity and heat diffusion from the heat generating layer 22 is reduced. Further, in the case of not using a foam body, it is desirable, in terms of heat resistance and flexibility, to use a material of a silicone rubber having a hardness of not more than 50 degrees (JIS-A).

The heat generating layer 22 of this example is formed on the elastic layer 23 as a coating of 60 μm thickness that is formed of a base material of a silicone rubber in which scale-like pieces of nickel are dispersed. Alternating magnetic flux generated by the excitation coil 36 passes through the heat generating layer 22 by way of the nickel pieces in the heat generating layer 22. This causes an eddy current to be generated in the nickel pieces, so that the heat generating layer 22 is heated rapidly. In this example, the base material of the heat generating layer 22 was formed from a silicone rubber. However, in place of a silicone rubber, heat-resistant resin or heat-resistant rubber that has flexibility such as polyimide resin, fluorocarbon resin, fluorocarbon rubber or the like also can be used. Further, a filler to be dispersed in the base material is not limited to the above-mentioned nickel pieces, and a magnetic metal powder and a non-magnetic metal powder also may be used in the form of a mixture or a laminate of these powders so as to be dispersed in the base material. Particles of such powders may have any of the shapes of a fiber, a sphere, a scale and the like. Needless to say, a filler to be dispersed is required only to be formed of a conductive material through which an eddy current flows due to alternating magnetic flux. In this example, however, particularly, a magnetic metal of nickel was used as a filler. Thus, heating can be performed efficiently because: alternating magnetic flux generated by the excitation coil 36 can be led into the heat generating layer 22; a magnetic resistance of a magnetic circuit formed by a magnetic flux flow around the excitation coil 36 can be reduced; and magnetic flux (leakage magnetic flux) penetrating the heat generating layer 22 and then leaking to another layer can be decreased. It is preferable that the heat generating layer 22 has a thickness of 10 to 200 μm.

The elastic layer (second elastic layer) 26 is provided so as to improve adhesion to the recording material 11. In this example, the elastic layer 26 is formed of a silicone rubber layer having a thickness of 200 μm and a hardness of 20 degrees (JIS-A). The thickness of the elastic layer 26 is not limited to 200 μm, and it is desirable to set the thickness to be in a range of 50 to 500 μm. In the case where the thickness of the elastic layer 26 is too large, due to the thermal capacity being too large, a longer warm-up time is required. In the case where the thickness of the elastic layer 26 is too small, the effect of providing adhesion to the recording material 11 is deteriorated. The material of the elastic layer 26 is not limited to a silicone rubber, and other types of heat-resistant rubber and hear-resistant resin also can be used. Although the elastic layer 26 is not necessarily provided and a configuration without the elastic layer 26 poses no problem, it is desirable to provide the elastic layer 26 in the case of obtaining a toner image as a color image.

The mold releasing layer 27 can be formed from a fluorocarbon resin such as PTFE (polytetrafluoroethylene), PFA (tetrafluoroethylene-perfluoroalkylvinyl ether copolymer), FEP (tetrafluoroethylene hexafluoropropylene copolymer) or the like. In this example, the mold releasing layer 27 was set to have a thickness of 30 μm.

The heat generating roller 21 used in this example is formed by the following manufacturing method. That is, after the elastic layer 23 is formed by foam-molding (it is preferable that the elastic layer 23 has a skin layer on its surface), a coating of an undiluted liquid of a silicone rubber in which a conductive filler is dispersed is applied on the elastic layer 23 in a predetermined thickness by a spray method, a dipping method or the like. Then, the coating is subjected to vulcanization, and thus the heat generating layer 22 is formed on the elastic layer 23. In this case, the core material 24 may be bonded fixedly to the elastic layer 23 before the formation of the heat generating layer 22. Further, the core material 24 may be inserted into and bonded to an inner portion of the elastic layer 23 after the formation of the heat generating layer 22. Further, it also is possible to form the elastic layer 23 by molding directly on the core material 24. Further, the heat generating layer 22 may be formed of a plurality of coatings. After the heat generating layer 22 is formed on the elastic layer 23, in the same manner that the heat generating layer 22 is formed, coatings of a silicone rubber that is used for the elastic layer (second elastic layer) 26 are applied on the heat generating layer 22. Then, the coatings are subjected to vulcanization. After that, the mold releasing layer 27 is formed by, for example, the following method. That is, a PFA tube is fitted around the elastic layer 26 and then is bonded thereto through a primer layer, or the elastic layer 26 is coated with PTFE and then a body thus obtained is subjected to sintering. Between the layers in each pair of the adjacent layers, a primer layer selected so as to correspond to the materials of the layers may be interposed. Further, as in the above-mentioned case, also in the case of using a polyimide resin for the base material of the heat generating layer 22, the heat generating layer 22 is formed by applying a coating of a polyimide varnish on the elastic layer 23.

In the present invention, as described above, instead of forming a tube in the form of, for example, a metallic belt as the heat generating layer 22 separately from the elastic layer 23, the heat generating layer 22 is formed directly on the elastic layer 23. This allows the manufacturing process steps to be simplified and thus provides ease of work integration, thereby achieving lower manufacturing cost.

According to Embodiment 1 described above, the base material of the heat generating layer 22 is formed of a flexible material of resin or rubber and not of a thin metal layer. Thus, the induction heat generating layer 22 is deformed easily, thereby allowing the nip part 34 having a large width for the width W to be formed. Further, the induction heat generating layer 22 is increased in durability with respect to repeated bending.

Furthermore, the heat generating layer 22 is formed of the base material of heat-resistant resin or heat-resistant rubber such as silicone rubber in which the conductive filler is dispersed. Thus, the induction heat generating layer 22 can be formed easily on the elastic layer 23 by coating or the like. Further, the heat generating layer 22 also is increased in flexibility.

The elastic layer 23 has a high heat insulating property as well as flexibility and heat resistance, and thus the temperature of the heat generating roller 22 can be increased rapidly.

The heat generating layer 22 is formed directly on the elastic layer 23. Thus, compared with the case of a heat generating roller formed in the conventional manner in which as an induction heat generating layer, a tube formed of a thin metal layer is formed separately from an elastic layer and then is fitted around the elastic layer, processing is made easier. Further, in the case where a tube is bonded, if unevenness results from bonding, such unevenness is likely to cause variations in the surface temperature of a roller. On the contrary, in the case where the heat generating layer 22 is formed directly on the elastic layer 23 as in the present invention, joining of the layers is achieved without causing unevenness, and thus variations in the surface temperature of the roller hardly occur.

In the above-mentioned embodiment, the heat generating roller 21 has a layer configuration in which the elastic layer 23, the heat generating layer 22, the second elastic layer 26, and the mold releasing layer 27 are provided in this order on the core material 24. However, the present invention is not necessarily limited to this layer configuration. The following configurations also are allowable. That is, the respective layers may have a multi-layer configuration. Further, between the respective layers in each pair of the adjacent layers, an adhesive layer may be provided or an auxiliary layer may be formed.

### EMBODIMENT 2

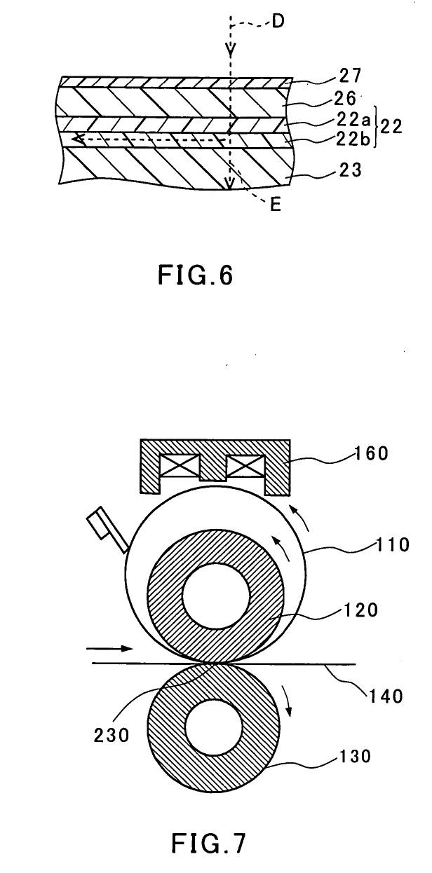

FIG. 6 is an expanded sectional view of a portion in the vicinity of a surface of a heat generating roller 21 according to Embodiment 2 of the present invention. In FIG. 6, like reference characters indicate like members that have the same functions as those of the members described with regard to Embodiment 1, for which detailed descriptions are omitted.

The only difference between Embodiment 2 and Embodiment 1 lies in the configuration of a heat generating layer 22 of the heat generating roller 21.

As shown in FIG. 6, in this embodiment, the heat generating layer 22 has a two-layer configuration of a conductive layer 22a formed of a base material of a silicone rubber in which scale-like particles of a silver powder as a conductive filler are dispersed and a magnetic body layer 22b formed also of a base material of a silicone rubber in which an iron powder is dispersed as a magnetic filler. During the operation of an excitation coil 36, alternating magnetic flux is generated in such a manner as to flow around the excitation coil 36. Most of such alternating magnetic flux penetrates the conductive layer 22a and then passes through the magnetic body layer 22b as indicated by a broken line D in FIG. 6. Thus, an eddy current is generated in the conductive layer 22a, so that the conductive layer 22a generates heat. At the same time, similarly, an eddy current also is generated in the magnetic body layer 22b, so that the magnetic body layer 22b generates heat. It is preferable that a filler to be dispersed in the conductive layer 22a is a material having as low a specific resistance as possible, and materials that can be used desirably include, for example, gold, silver, copper, aluminum, and the like.

In the case where the conductive layer 22a is provided on an outer side of the magnetic body layer 22b, the heat generation efficiency can be increased more than in the case described with regard to Embodiment 1 in which the heat generating layer 22 is formed of a magnetic body layer as a single layer.

Furthermore, an eddy current is generated in the conductive layer 22i a, and the magnetic body layer 22b is provided on an inner circumferential side of the conductive layer 22a. Thus, leakage magnetic flux E, which is magnetic flux penetrating the magnetic body layer 22b in a radial direction of the heat generating roller 21 and then leaking therefrom, can be decreased. When the leakage magnetic flux E reaches a core material 24, in the case where the core material 24 is formed of a metallic material, an eddy current is generated in the core material 24, so that the core material 24 generates heat. However, in this embodiment, since the leakage magnetic flux E can be decreased, an amount of heat generated in the core material 24 can be decreased. In the case where the core material 24 is formed of an insulating material as described with regard to Embodiment 1, no heat is generated in the core material 24. However, PPS that is used in Embodiment 1 as an example has low mechanical strength, and alumina is a costly material. According to this embodiment, since the leakage magnetic flux E reaching the core material 24 can be decreased, even in the case where the core material 24 is formed of a less costly and commonly-used metallic material that allows sufficient strength to be secured, the generation of heat in the core material 24 can be suppressed.

As described above, according to this embodiment, the leakage magnetic flux E can be decreased, and thus efficient heat generation can be achieved in the heat generating layer 22. This allows a loss of energy to be reduced. Further, since the leakage magnetic flux E is decreased, magnetic flux reaching the core material 24 can be decreased. Thus, the core material 24 is not required to be formed of an insulating material and can be formed of a metallic material in common use, thereby allowing sufficient mechanical strength to be secured at lower cost. Moreover, since the generation of heat in the core material 24 can be suppressed, problems occurring due to heating of bearings 28 and 28′ of the core material 24 also can be reduced.

The embodiments disclosed in this application are intended to illustrate the technical aspects of the invention and not to limit the invention thereto. The invention may be embodied in other forms without departing from the spirit and the scope of the invention as indicated by the appended claims and is to be broadly construed.

1. An electromagnetic induction heat generating roller comprising at least a mold releasing layer, an induction heat generating layer, an elastic layer, and a core material, which are provided in this order from a surface, the electromagnetic induction heat generating roller being in contact under pressure with a pressing member so as to form a nip part and causing a temperature increase in a material to be heated being passed through the nip part,
wherein the induction heat generating layer includes a layer formed of a base material of heat-resistant resin or heat-resistant rubber in which a conductive filler is dispersed.

2. The electromagnetic induction heat generating roller according to claim 1,
wherein the induction heat generating layer is formed of a laminate of a layer formed of a base material in which a conductive filler is dispersed and a layer formed of a base material in which a magnetic filler having a resistance higher than that of the conductive filler is dispersed.

3. The electromagnetic induction heat generating roller according to claim 1,
wherein the base material of the induction heat generating layer is formed from a silicone rubber.

4. The electromagnetic induction heat generating roller according to claim 1,
wherein the elastic layer is formed from a foamed silicone rubber.

5. The electromagnetic induction heat generating roller according to claim 1,
wherein the induction heat generating layer is formed directly on a surface of the elastic layer by coating or spraying.

6. The electromagnetic induction heat generating roller according to claim 1,
wherein a second elastic layer is provided between the mold releasing layer and the induction heat generating layer.

7. A method of manufacturing an electromagnetic induction heat generating roller as claimed in claim 1, comprising at least the steps of:
forming the induction heat generating layer on the elastic layer by coating or spraying; and
forming the mold releasing layer on the induction heat generating layer.

8. A method of manufacturing an electromagnetic induction heat generating roller as claimed in claim 6, comprising at least the steps of:
forming the induction heat generating layer on the elastic layer by coating or spraying;
forming the second elastic layer on the induction heat generating layer; and
forming the mold releasing layer on the second elastic layer.

9. A heating device, comprising:
an electromagnetic induction heat generating roller as claimed in claim 1;
a pressing roller that is in contact under pressure with the electromagnetic induction heat generating roller so as to form the nip part; and
a magnetic field generating unit that applies a magnetic field to the induction heat generating layer of the electromagnetic induction heat generating roller so that the induction heat generating layer generates heat by induction,
wherein a material to be heated that is introduced into the nip part is conveyed under pressure by the electromagnetic induction heat generating roller and the pressing roller so as to be heated continuously.

10. An image forming apparatus, comprising:
an image forming unit that forms a toner image on a recording material; and
a heating device as claimed in claim 9,
wherein the toner image to be fixed formed on the recording material by the image forming unit is fixed on the recording material by the heating device.
